(19) United States
(12) Patent Application Publication
(10) Pub. No.: US 2019/0009224 A1
(43) Pub. Date: Jan. 10, 2019

(54) POROUS POLYMER MEMBRANES COMPRISING SILICATE

(71) Applicants: SOLVAY SPECIALTY POLYMERS ITALY S.P.A., Bollate (IT); RHODIA OPERATIONS, Paris (FR); RHODIA POLIAMIDA E ESPECIALIDADES LTDA, Sao Paulo (BR)

(72) Inventors: Emanuele DI NICOLO', Gorla Minore (IT); Pasquale CAMPANELLI, Limbiate (IT); Philippe MARCHAL, Saint-Genis Laval (FR); Sébastien LOGETTE, Villeurbanne (FR); Tarcis CORDEIRO BASTOS, São Paulo (BR)

(21) Appl. No.: 16/065,767

(22) PCT Filed: Dec. 22, 2016
(86) PCT No.: PCT/EP2016/082392

§ 371 Date: Jun. 22, 2018

(30) Foreign Application Priority Data
Dec. 23, 2015 (EP) 15307124.6

(51) Int. Cl. B01D 69/14; B01D 71/68; B01D 71/02; B01D 67/00; B01D 69/12; B01D 69/02; B01D 61/14; B01D 65/08

(52) U.S. Cl. CPC B01D 69/148; B01D 71/68; B01D 71/027; B01D 67/0079; B01D 2325/24; B01D 69/02; B01D 61/14; B01D 65/08; B01D 69/125

(57) ABSTRACT

The present invention pertains to a porous membrane, to a process for manufacturing said porous membrane and to use of said porous membrane as filtration membrane for liquid and/or gas phases, in particular water-based phases.

This application claims priority to European application No. EP 15307124.6 filed on Dec. 23, 2015, the whole content of this application being incorporated herein by reference for all purposes.

### TECHNICAL FIELD

The present invention pertains to a porous membrane, to a process for manufacturing said porous membrane and to use of said porous membrane as filtration membrane for liquid and/or gas phases, in particular water-based phases.

### BACKGROUND ART

Aromatic polymers are widely used in the preparation of microfiltration and ultrafiltration membranes due to their good mechanical strength and thermal stability.

The key property of a porous membrane is its ability to control the permeation rate of chemical species through the membrane itself. This feature is exploited in many different applications like separation applications (water and gas) or drug delivery applications.

Polymeric membranes suitable for use as microfiltration and ultrafiltration typically control the permeation under a “sieve” mechanism since the passage of liquid or gas is mainly governed by a convective flux. Such polymeric membranes are mainly produced by phase inversion methods which can give raise to items with very large fraction of voids (porosity).

A homogeneous polymeric solution containing a polymer, a suitable solvent and/or a co-solvent and, optionally, one or more additives is typically processed by casting into a film and then brought to precipitation by contacting it with a non-solvent medium by the so-called Non-Solvent Induced Phase Separation (NIPS) process. The non-solvent medium is usually water or a mixture of water and surfactants, alcohols and/or the solvent itself.

Precipitation can also be obtained by decreasing the temperature of the polymeric solution by the so-called Thermal Induced Phase Separation (TIPS) process.

Alternatively, the precipitation may be induced by contacting the film processed by casting with air at a very high water vapour content by the so-called Vapour Induced Phase Separation (VIPS) process.

Still, the precipitation may be induced by evaporation of the solvent from the film processed by casting by the so-called Evaporation Induced Phase Separation (EIPS) process.

It remains nevertheless key to provide for porous membranes exhibiting improved water permeability and improved (bio)fouling resistance, while maintaining good mechanical properties, to be suitably used for filtration of various liquid and/or gas phases.

### SUMMARY OF INVENTION

It has been now surprisingly found that the porous membrane of the invention advantageously exhibits improved biofouling resistance and improved mechanical properties to be suitably used as filtration membrane for various liquid and/or gas phases, in particular water-based phases.

Also, it has been found that the porous membrane of the invention advantageously exhibits good water flux properties to be suitably used as filtration membrane for water-based phases.

In a first instance, the present invention pertains to a porous membrane comprising at least one layer consisting of a composition [composition (C)] comprising:
at least one aromatic polymer [polymer (A)], and
at least one silicate compound [compound (S)].

In a second instance, the present invention pertains to a process for manufacturing a porous membrane, said process comprising:

(i) providing a composition [composition (C)] comprising:
at least one aromatic polymer [polymer (A)], and
at least one silicate compound [compound (S)];

(ii) processing the composition (C) provided in step (i) thereby providing a film; and

(iii) processing the film provided in step (ii) thereby providing a porous membrane.

The porous membrane of the invention is advantageously obtainable by the process of the invention.

The term “membrane” is used herein in its usual meaning, that is to say that it refers to a discrete, generally thin, interface that moderates the permeation of chemical species in contact with it, said membrane containing pores of finite dimensions.

Membranes containing pores homogeneously distributed throughout their thickness are generally known as symmetric (or isotropic) membranes; membranes containing pores which are heterogeneously distributed throughout their thickness are generally known as asymmetric (or anisotropic) membranes.

The porous membrane obtainable by the process of the invention may be either a symmetric membrane or an asymmetric membrane.

The asymmetric porous membrane obtainable by the process of the invention typically consists of one or more layers containing pores which are heterogeneously distributed throughout their thickness.

The asymmetric porous membrane obtainable by the process of the invention typically comprises an outer layer containing pores having an average pore diameter smaller than the average pore diameter of the pores in one or more inner layers.

The porous membrane of the invention typically has an average pore diameter of at least 0.001 μm, of at least 0.005 μm, of at least 0.01 μm and of at most 50 μm.

Suitable techniques for the determination of the average pore diameter in the porous membranes of the invention are described for instance in Handbook of Industrial Membrane Technology. Edited by PORTER, Mark C. Noyes Publications, 1990. p. 70-78.

The porous membrane of the invention typically has a gravimetric porosity comprised between 5% and 90%, preferably between 10% and 85% by volume, more preferably between 50% and 80%, based on the total volume of the membrane.

For the purpose of the present invention, the term “gravimetric porosity” is intended to denote the fraction of voids over the total volume of the porous membrane.

Suitable techniques for the determination of the gravimetric porosity in the porous membranes of the invention are described for instance in SMOLDERS, K., et al. Terminology for Membrane Distillation. Desalination. 1989, vol. 72, p. 249-262.

Under step (i) of the process for manufacturing a porous membrane according to the invention, the composition (C) is typically manufactured by any conventional techniques.

Under step (ii) of the process for manufacturing a porous membrane according to the invention, conventional techniques can be used for processing the composition (C) thereby providing a film.

The term “film” is used herein to refer to a layer of composition (C) obtained after processing of the same under step (ii) of the process of the invention. The term “film” is used herein in its usual meaning, that is to say that it refers to a discrete, generally thin, dense layer.

Depending on the final form of the membrane, the film may be either flat, when flat membranes are required, or tubular in shape, when tubular or hollow fiber membranes are required.

According to a first embodiment of the invention, the process for manufacturing a porous membrane is carried out in liquid phase.

The process according to this first embodiment of the invention typically comprises:

(i) providing a liquid composition [liquid composition (C)] comprising:
at least one aromatic polymer [polymer (A)],
at least one silicate compound [compound (S)], and
a liquid medium comprising at least one organic solvent [medium (L)];

(ii) processing the liquid composition (C) provided in step (i) thereby providing a film; and

(iii) precipitating the film provided in step (ii) thereby providing a porous membrane.

The liquid composition (C) is advantageously a homogeneous solution comprising:
at least one aromatic polymer [polymer (A)],
at least one silicate compound [compound (S)], and
a liquid medium comprising at least one organic solvent [medium (L)].

The term “solvent” is used herein in its usual meaning, that is it indicates a substance capable of dissolving another substance (solute) to form an uniformly dispersed mixture at the molecular level. In the case of a polymeric solute, it is common practice to refer to a solution of the polymer in a solvent when the resulting mixture is transparent and no phase separation is visible in the system. Phase separation is taken to be the point, often referred to as “cloud point”, at which the solution becomes turbid or cloudy due to the formation of polymer aggregates.

The medium (L) typically comprises at least one organic solvent selected from the group consisting of:
aliphatic hydrocarbons including, more particularly, the paraffins such as, in particular, pentane, hexane, heptane, octane, nonane, decane, undecane, dodecane or cyclohexane, and naphthalene and aromatic hydrocarbons and more particularly aromatic hydrocarbons such as, in particular, benzene, toluene, xylenes, cumene, petroleum fractions composed of a mixture of alkylbenzenes;
aliphatic or aromatic halogenated hydrocarbons including more particularly, perchlorinated hydrocarbons such as, in particular, tetrachloroethylene, hexachloroethane;
partially chlorinated hydrocarbons such as dichloromethane, chloroform, 1,2-dichloroethane, 1,1,1-trichloroethane, 1,1,2,2-tetrachloroethane, pentachloroethane, trichloroethylene, 1-chlorobutane, 1,2-dichlorobutane, monochlorobenzene, 1,2-dichlorobenzene, 1,3-dichlorobenzene, 1,4-dichlorobenzene, 1,2,4-trichlorobenzene or mixture of different chlorobenzenes;
aliphatic, cycloaliphatic or aromatic ether oxides, more particularly, diethyl oxide, dipropyl oxide, diisopropyl oxide, dibutyl oxide, methyltertiobutylether, dipentyl oxide, diisopentyl oxide, ethylene glycol dimethyl ether, ethylene glycol diethyl ether, ethylene glycol dibutyl ether benzyl oxide; dioxane, tetrahydrofuran (THF);
glycol ethers such as ethylene glycol monomethyl ether, ethylene glycol monoethyl ether, ethylene glycol monopropyl ether, ethylene glycol monoisopropyl ether, ethylene glycol monobutyl ether, ethylene glycol monophenyl ether, ethylene glycol monobenzyl ether, diethylene glycol monomethyl ether, diethylene glycol monoethyl ether, diethylene glycol mono-n-butyl ether;
glycol ether esters such as ethylene glycol methyl ether acetate, ethylene glycol monoethyl ether acetate, ethylene glycol monobutyl ether acetate;
alcohols, including polyhydric alcohols, such as methyl alcohol, ethyl alcohol, diacetone alcohol, ethylene glycol;
ketones such as acetone, methylethylketone, methylisobutyl ketone, diisobutylketone, cyclohexanone, isophorone;
linear or cyclic esters such as isopropyl acetate, n-butyl acetate, methyl acetoacetate, dimethyl phthalate, γ-butyrolactone;
linear or cyclic carboxamides such as N,N-dimethylacetamide (DMAC), N,N-diethylacetamide, dimethylformamide (DMF), diethylformamide or N-methyl-2-pyrrolidone (NMP);
organic carbonates for example dimethyl carbonate, diethyl carbonate, dipropyl carbonate, dibutyl carbonate, ethylmethyl carbonate, ethylene carbonate, vinylene carbonate;
phosphoric esters such as trimethyl phosphate, triethyl phosphate;
ureas such as tetramethylurea, tetraethylurea.

The medium (L) typically comprises at least 50% by weight of at least one organic solvent.

The medium (L) may further comprise at least one non-solvent medium [medium (NS)]. The medium (NS) may comprise water.

Under step (i) of the process for manufacturing a porous membrane according to the first embodiment of the invention, the liquid composition (C) is typically manufactured by any conventional techniques. For instance, the medium (L) may be added to the polymer (A), or, preferably, the polymer (A) may be added to the medium (L), or even the polymer (A) and the medium (L) may be simultaneously mixed.

Any suitable mixing equipment may be used. Preferably, the mixing equipment is selected to reduce the amount of air entrapped in the liquid composition (C) which may cause defects in the final membrane. The mixing of the polymer (A) and the medium (L) may be conveniently carried out in a sealed container, optionally held under an inert atmosphere. Inert atmosphere, and more precisely nitrogen atmosphere has been found particularly advantageous for the manufacture of the liquid composition (C).

Under step (i) of the process for manufacturing a porous membrane according to the first embodiment of the invention, the mixing time during stirring required to obtain a clear homogeneous liquid composition (C) can vary widely depending upon the rate of dissolution of the components, the temperature, the efficiency of the mixing apparatus, the viscosity of the liquid composition (C) and the like.

Under step (ii) of the process for manufacturing a porous membrane according to this first embodiment of the invention, the liquid composition (C) is typically processed in liquid phase.

Under step (ii) of the process for manufacturing a porous membrane according to this first embodiment of the invention, the liquid composition (C) is typically processed by casting thereby providing a film.

Casting generally involves solution casting, wherein typically a casting knife, a draw-down bar or a slot die is used to spread an even film of a liquid composition comprising a suitable medium (L) across a suitable support.

Under step (ii) of the process for manufacturing a porous membrane according to this first embodiment of the invention, the temperature at which the liquid composition (C) is processed by casting may be or may be not the same as the temperature at which the liquid composition (C) is mixed under stirring.

Different casting techniques are used depending on the final form of the membrane to be manufactured.

When the final product is a flat membrane, the liquid composition (C) is cast as a film over a flat supporting substrate, typically a plate, a belt or a fabric, or another microporous supporting membrane, typically by means of a casting knife, a draw-down bar or a slot die.

According to a first embodiment of the invention, under step (ii) of the process for manufacturing a porous membrane according to this first embodiment of the invention, the liquid composition (C) is processed by casting onto a flat supporting substrate thereby providing a flat film.

According to a second embodiment of the invention, under step (ii) of the process for manufacturing a porous membrane according to this first embodiment of the invention, the liquid composition (C) is processed by casting thereby providing a tubular film.

According to a variant of this second embodiment of the invention, the tubular film is manufactured using a spinneret.

The term “spinneret” is hereby understood to mean an annular nozzle comprising at least two concentric capillaries: a first outer capillary for the passage of the liquid composition (C) and a second inner one for the passage of a supporting fluid, generally referred to as “lumen”.

Hollow fibers and capillary membranes may be manufactured by the so-called spinning process according to this variant of the second embodiment of the invention. According to this variant of the second embodiment of the invention, the liquid composition (C) is generally pumped through the spinneret. The lumen acts as the support for the casting of the liquid composition (C) and maintains the bore of the hollow fiber or capillary precursor open. The lumen may be a gas, or, preferably, a medium (NS) or a mixture of the medium (NS) with a medium (L). The selection of the lumen and its temperature depends on the required characteristics of the final membrane as they may have a significant effect on the size and distribution of the pores in the membrane.

At the exit of the spinneret, after a short residence time in air or in a controlled atmosphere, under step (iii) of the process for manufacturing a porous membrane according to this first embodiment of the invention, the hollow fiber or capillary precursor is precipitated thereby providing the hollow fiber or capillary membrane.

The supporting fluid forms the bore of the final hollow fiber or capillary membrane.

Tubular membranes, because of their larger diameter, are generally manufactured using a different process from the one employed for the production of hollow fiber membranes.

According to a first variant of this first embodiment of the invention, the process for manufacturing a porous membrane comprises:

(i) providing a liquid composition [liquid composition (C)] comprising:
at least one aromatic polymer [polymer (A)],
at least one silicate compound [compound (S)], and
a liquid medium comprising at least one organic solvent [medium (L)];

(ii) processing the liquid composition (C) provided in step (i) thereby providing a film; and

(iii) precipitating the film provided in step (ii) in a non-solvent medium [medium (NS)] thereby providing a porous membrane.

Under step (i) of the process according to this first variant of this first embodiment of the invention, the medium (L) typically further comprises water.

Under step (iii) of the process according to this first variant of this first embodiment of the invention, the medium (NS) typically comprises water and, optionally, at least one organic solvent.

According to a second variant of this first embodiment of the invention, the process for manufacturing a porous membrane comprises:

(i) providing a liquid composition [liquid composition (C)] comprising:
at least one aromatic polymer [polymer (A)],
at least one silicate compound [compound (S)], and
a liquid medium comprising at least one organic solvent [medium (L)];

(ii) processing the liquid composition (C) provided in step (i) thereby providing a film; and

(iii) precipitating the film provided in step (ii) by cooling thereby providing a porous membrane.

Under step (i) of the process according to this second variant of this first embodiment of the invention, the medium (L) of the liquid composition (C) advantageously comprises at least one latent organic solvent.

For the purpose of the present invention, the term “latent” is intended to denote an organic solvent which behaves as an active solvent only when heated above a certain temperature.

Under step (ii) of the process according to this second variant of this first embodiment of the invention, the film is typically processed at a temperature high enough to maintain the liquid composition (C) as a homogeneous solution.

Under step (ii) of the process according to this second variant of this first embodiment of the invention, the film is typically processed at a temperature comprised between 100° C. and 250° C., preferably between 120° C. and 220°, more preferably between 140° C. and 190° C.

Under step (iii) of the process according to this second variant of this first embodiment of the invention, the film provided in step (ii) is typically precipitated by cooling to a temperature below 100° C., preferably below 60° C., more preferably below 40° C., typically using any conventional techniques.

Under step (iii) of the process according to this second variant of this first embodiment of the invention, cooling is typically carried out by contacting the film provided in step (ii) with a liquid medium [medium (L′)].

Under step (iii) of the process according to this second variant of this first embodiment of the invention, the medium (L′) typically comprises, preferably consists of, water.

Alternatively, under step (iii) of the process according to this second variant of this first embodiment of the invention, cooling is typically carried out by contacting the film provided in step (ii) with air.

Under step (iii) of the process according to this second variant of this first embodiment of the invention, either the medium (L′) or air is typically maintained at a temperature below 100° C., preferably below 60° C., more preferably below 40° C.

According to a third variant of this first embodiment of the invention, the process for manufacturing a porous membrane comprises:

(i) providing a liquid composition [liquid composition (C)] comprising:
at least one aromatic polymer [polymer (A)],
at least one silicate compound [compound (S)], and
a liquid medium comprising at least one organic solvent [medium (L)];

(ii) processing the liquid composition (C) provided in step (i) thereby providing a film; and

(iii) precipitating the film provided in step (ii) by absorption of a non-solvent medium [medium (NS)] from a vapour phase thereby providing a porous membrane.

Under step (iii) of the process according to this third variant of this first embodiment of the invention, the film provided in step (ii) is typically precipitated by absorption of water from a water vapour phase.

Under step (iii) of the process according to this third variant of this first embodiment of the invention, the film provided in step (ii) is typically precipitated under air, typically having a relative humidity higher than 10%, preferably higher than 50%.

According to a fourth variant of this first embodiment of the invention, the process for manufacturing a porous membrane comprises:

(i) providing a liquid composition [liquid composition (C)] comprising:
at least one aromatic polymer [polymer (A)],
at least one silicate compound [compound (S)], and
a liquid medium comprising at least one organic solvent [medium (L)];

(ii) processing the liquid composition (C) provided in step (i) thereby providing a film; and

(iii) precipitating the film provided in step (ii) by evaporation of the medium (L) thereby providing a porous membrane.

Under step (iii) of the process according to this fourth variant of this first embodiment of the invention, should the medium (L) comprise more than one organic solvents, the film provided in step (ii) is typically precipitated by evaporation of the medium (L) at a temperature above the boiling point of the organic solvent having the lowest boiling point.

For the purpose of the present invention, by the term “non-solvent medium [medium (NS)]” it is meant a medium consisting of one or more liquid substances incapable of dissolving the composition (C) at a given temperature.

The medium (NS) typically comprises water and, optionally, at least one organic solvent selected from alcohols or polyalcohols, preferably aliphatic alcohols having a short chain, for example from 1 to 6 carbon atoms, more preferably methanol, ethanol, isopropanol and ethylene glycol.

The medium (NS) is generally selected among those miscible with the medium (L) used for the preparation of the liquid composition (C).

The medium (NS) may further comprise the medium (L).

More preferably, the medium (NS) consists of water. Water is the most inexpensive non-solvent medium and can be used in large amounts.

The medium (L) is advantageously soluble in water, which is an additional advantage of the process of the present invention.

The Applicant has found that use of solvent/non-solvent mixtures in any one of steps (ii) and (iii) of the process for manufacturing a porous membrane according to the first embodiment of the invention at a given temperature advantageously allows controlling the morphology of the final porous membrane including its average porosity.

The temperature gradient between the film provided in any one of steps (ii) and (iii) of the process for manufacturing a porous membrane according to the first embodiment of the invention and the medium (NS) may also influence the pore size and/or pore distribution in the final porous membrane as it generally affects the rate of precipitation of the polymer (A) from the liquid composition (C).

The process for manufacturing a porous membrane according to this first embodiment of the invention may comprise any combination of the first, second, third and fourth variants as defined above. For instance, the porous membrane of the invention may be obtainable by the process according to the second variant of the first embodiment of the invention followed by the process according to the first variant of the first embodiment of the invention.

The porous membrane obtainable by the process according to this first embodiment of the invention may undergo additional post treatment steps, for instance rinsing and/or stretching.

The porous membrane obtainable by the process according to this first embodiment of the invention is typically rinsed using a liquid medium miscible with the medium (L).

The porous membrane obtainable by the process according to this first embodiment of the invention may be advantageously stretched so as to increase its average porosity.

According to a second embodiment of the invention, the process for manufacturing a porous membrane is carried out in molten phase.

The process according to this second embodiment of the invention typically comprises:

(i) providing a solid composition [solid composition (C)] comprising:
at least one aromatic polymer [polymer (A)], and
at least one silicate compound [compound (S)];

(ii) processing the solid composition (C) provided in step (i) thereby providing a film; and

(iii) stretching the film provided in step (ii).

Under step (ii) of the process for manufacturing a porous membrane according to this second embodiment of the invention, the solid composition (C) is typically processed in molten phase.

Under step (ii) of the process for manufacturing a porous membrane according to this second embodiment of the invention, the solid composition (C) is typically processed by melt forming thereby providing a film. Melt forming is commonly used to make dense films by film extrusion, preferably by flat cast film extrusion or by blown film extrusion. According to this technique, the solid composition (C) is extruded through a die so as to obtain a molten tape, which is then calibrated and stretched in the two directions until obtaining the required thickness and wideness. The solid composition (C) is melt compounded for obtaining a molten composition. Generally, melt compounding is carried out in an extruder. The solid composition (C) is typically extruded through a die at temperatures of generally lower than 250° C., preferably lower than 200° C. thereby providing strands which are typically cut thereby providing pellets.

Twin screw extruders are preferred devices for accomplishing melt compounding of the solid composition (C).

Films can then be manufactured by processing the pellets so obtained through traditional film extrusion techniques. Film extrusion is preferably accomplished through a flat cast film extrusion process or a hot blown film extrusion process. Film extrusion is more preferably accomplished by a hot blown film extrusion process.

Under step (iii) of the process according to this second embodiment of the invention, the film provided in step (ii) may be stretched either in molten phase or after its solidification upon cooling.

Under step (iii) of the process according to this second embodiment of the invention, the film provided in step (ii) is advantageously stretched at right angle to the original orientation, so that the crystalline structure of the polymer (A) is typically deformed and slit-like voids are advantageously formed.

The porous membrane obtainable by the process of the invention is typically dried, preferably at a temperature of at least 30° C.

Drying can be performed under air or a modified atmosphere, e.g. under an inert gas, typically exempt from moisture (water vapour content of less than 0.001% v/v). Drying can alternatively be performed under vacuum.

The porous membrane of the invention may be in the form of flat membranes or in the form of tubular membranes.

Flat membranes are generally preferred when high fluxes are required whereas hollow fibers membranes are particularly advantageous in applications wherein compact modules having high surface areas are required.

Flat membranes typically have a thickness comprised between 20 μm and 200 μm.

Tubular membranes typically have an outer diameter greater than 3 mm. Tubular membranes having an outer diameter comprised between 0.5 mm and 3 mm are typically referred to as hollow fibers membranes. Tubular membranes having a diameter of less than 0.5 mm are typically referred to as capillary membranes.

The polymer (A) is typically selected from the group consisting of poly(arylene sulfide) polymers [polymers (PAS)] and aromatic sulfone polymers [polymers (SP)].

For the purpose of the present invention, the term “poly(arylene sulfide) polymer [polymer (PAS)]” is intended to denote any polymer comprising recurring units wherein more than 50% by moles of said recurring units are recurring units (R_{PAS}) of formula:

—(Ar—S)—

wherein Ar denotes an aromatic moiety comprising at least one aromatic mono- or poly-nuclear cycle, such as a phenylene or a naphthylene group, which is linked by each of its two ends to two sulfur atoms forming sulfide groups via a direct C—S linkage.

In recurring units (R_{PAS}), the aromatic moiety Ar may be substituted by one or more substituent groups, including but not limited to halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups, and substituted or unsubstituted arylene sulfide groups, the arylene groups of which are also linked by each of their two ends to two sulfur atoms forming sulfide groups via a direct C—S linkage thereby creating branched or cross-linked polymer chains.

The polymer (PAS) preferably comprises more than 70% by moles, more preferably more than 80% by moles, still more preferably more than 90% by moles of recurring units (R_{PAS}).

Most preferably, the polymer (PAS) contains no recurring units other than recurring units (R_{PAS}).

In recurring units (R_{PAS}), the aromatic moiety Ar is preferably selected from the group consisting of those of formulae (X-A) to (X-K) here below:

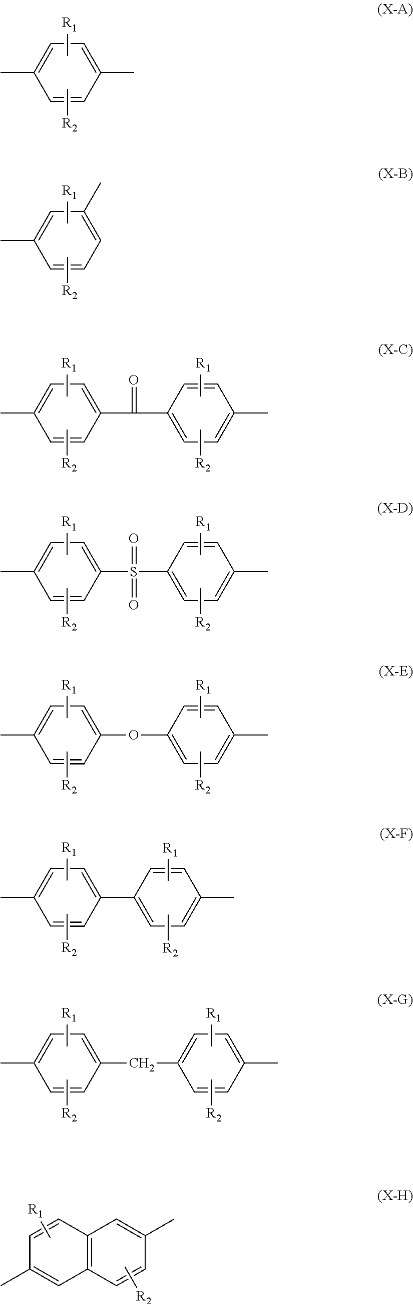

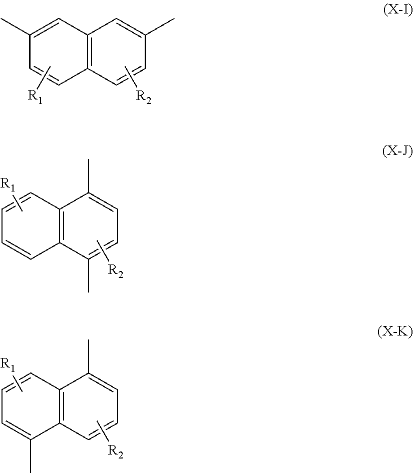

wherein R₁ and R₂, equal to or different from each other, are selected from the group consisting of hydrogen atoms, halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups, and substituted or unsubstituted arylene sulfide groups, the arylene groups of which are also linked by each of their two ends to two sulfur atoms forming sulfide groups via a direct C—S linkage thereby creating branched or cross-linked polymer chains.

The polymer (PAS) may be a homopolymer or a copolymer such as a random copolymer or a block copolymer.

The polymer (PAS) typically comprises one or more branched or cross-linked recurring units selected from the group consisting of those of formulae (X-L) to (X-N) here below:

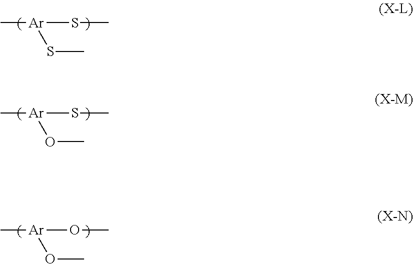

The polymer (PAS) is preferably a poly(phenylene sulfide) polymer [polymer (PPS)]. For the purpose of the present invention, the term “poly(phenylene sulfide) polymer [polymer (PPS)]” is intended to denote any polymer comprising recurring units wherein more than 50% by moles of said recurring units are p-phenylene sulfide recurring units (R_{PPS}) of formula:

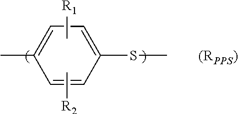

wherein the p-phenylene group is linked by each of its two ends to two sulfur atoms forming sulfide groups via a direct C—S linkage, wherein R₁ and R₂, equal to or different from each other, are selected from the group consisting of hydrogen atoms, halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups, and substituted or unsubstituted arylene sulfide groups, the arylene groups of which are also linked by each of their two ends to two sulfur atoms forming sulfide groups via a direct C—S linkage thereby creating branched or cross-linked polymer chains.

Non-limiting examples of polymers (PPS) suitable for the invention include those commercially available under the trademark names RYTON® from Solvay Specialty Polymers USA L.L.C., FORTRON® from Fortron Industries and UPEC® from GE Plastics.

For the purpose of the invention, the term “aromatic sulfone polymer [polymer (SP)]” is intended to denote any polymer comprising recurring units wherein more than 50% by moles of the recurring units of said polymer (SP) are connected by ether linkages in the main chain and comprise at least one group of formula —Ar—SO₂—Ar′— [recurring units (R_{SP})], wherein Ar and Ar′, equal to or different from each other, are aromatic groups.

In a first preferred embodiment of the invention, the recurring units (R_{SP}) of the polymer (SP) are preferably recurring units (R_{SP-1}) of formula:

—Ar¹-(T′-Ar²)ₙ—O—Ar³—SO₂—[Ar⁴-(T-Ar²)ₙ—SO₂]ₘ—Ar⁵—O— (R_{SP-1})

wherein:
Ar¹, Ar², Ar³, Ar⁴, and Ar⁵, equal to or different from each other and at each occurrence, are independently aromatic mono- or polynuclear groups;
T and T′, equal to or different from each other and at each occurrence, is independently a bond or a divalent group optionally comprising one or more than one heteroatoms; preferably T′ is selected from the group consisting of a bond, —CH₂—, —C(O)—, —C(CH₃)₂—, —C(CF₃)₂—, —C(═CCl₂)—, —SO₂—, —C(CH₃)(CH₂CH₂COOH)—, and a group of formula:

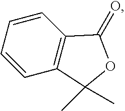

and

preferably T is selected from the group consisting of a bond, —CH₂—, —C(O)—, —C(CH₃)₂—, —C(CF₃)₂—, —C(═CCl₂)—, —C(CH₃)(CH₂CH₂COOH)—, and a group of formula:

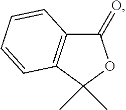

and
n and m, equal to or different from each other, are independently zero or an integer of 1 to 5.

Non limiting examples of polymers (SP) according to this first preferred embodiment of the invention include poly(phenylene sulfone) polymers [polymers (PPSU)], poly(sulfone) polymers [polymers (PSU)] and poly(ether sulfone) polymers [polymers (PESU)].

For the purpose of the invention, the term “poly(phenylene sulfone) polymer [polymer (PPSU)]” is intended to denote any polymer comprising recurring units wherein more than 50% by moles of the recurring units (R_{SP-1}) of said polymer (PPSU) are recurring units (R_{PPSU}) of formula (K-A):

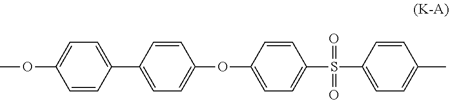

In a preferred embodiment of the present invention, more than 75% by moles, preferably more than 90% by moles, more preferably more than 99% by moles, even more preferably substantially all the recurring units (R_{SP-1}) of the polymer (PPSU) are recurring units (R_{PPSU}) of formula (K-A), chain defects or minor amounts of other recurring units might be present, being understood that these latter do not substantially modify the properties of the polymer (PPSU).

The polymer (PPSU) polymer may be notably a homopolymer or a copolymer such as a random copolymer or a block copolymer. When the (PPSU) polymer is a copolymer, its recurring units are advantageously a mix of recurring units (R_{PPSU}) of formula (K-A) and of recurring units (R_{PPSU*}), different from recurring units (R_{PPSU}), such as recurring units of formula (K-B), (K-C) or (K-D):

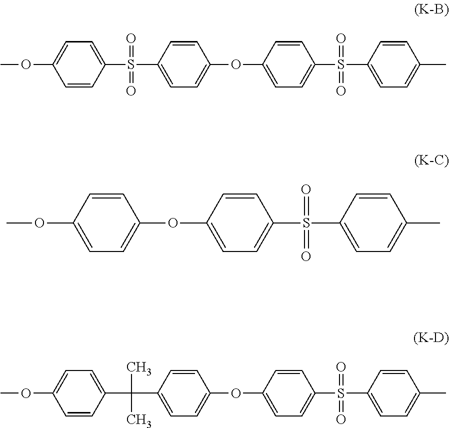

and mixtures thereof.

The polymer (PPSU) can also be a blend of a homopolymer and a copolymer as defined above.

Non-limiting examples of polymers (PPSU) suitable for the invention include those commercially available under the trademark names RADEL® R PPSU from Solvay Specialty Polymers USA L.L.C.

For the purpose of the present invention, the term “poly(sulfone) polymer [polymer (PSU)]” is intended to denote an aromatic sulfone polymer wherein at least 50% by moles, preferably at least 60% by moles, more preferably at least 70% by moles, even more preferably at least 80% by moles and most preferably at least 90% by moles of the recurring units (R_{SP-1}) of said polymer (PSU) are recurring units (R_{PSU}) of formula:

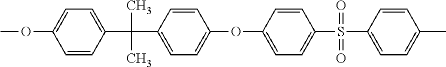

Non-limiting examples of polymers (PSU) suitable for the invention include those commercially available under the trademark name UDEL® PSU from Solvay Specialty Polymers USA L.L.C.

For the purpose of the present invention, the term “poly(ether sulfone) polymer [polymer (PESU)]” is intended to denote any polymer wherein more than 50% by moles of the recurring units (R_{SP-1}) of said polymer (PESU) are recurring units (R_{PESU}) of formula:

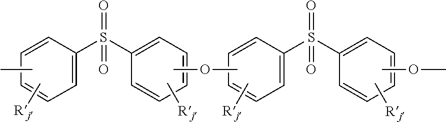

wherein each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium, and each of j′, equal to or different from each other and at each occurrence, is independently zero or is an integer from 0 to 4.

Preferred recurring units (R_{PESU}) are those complying with formula (I), shown below:

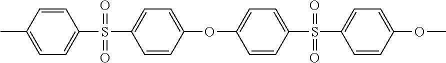

The polymer (PESU) may be notably a homopolymer or a copolymer such as a random or a block copolymer.

When the polymer (PESU) is a copolymer, its recurring units are advantageously a mix of recurring units (R_{PESU}), as defined above, and of recurring units (R_{PESU}*). The recurring units (R_{PESU}*) are typically selected from the group consisting of those of formulae (II), (III) and (IV) here below:

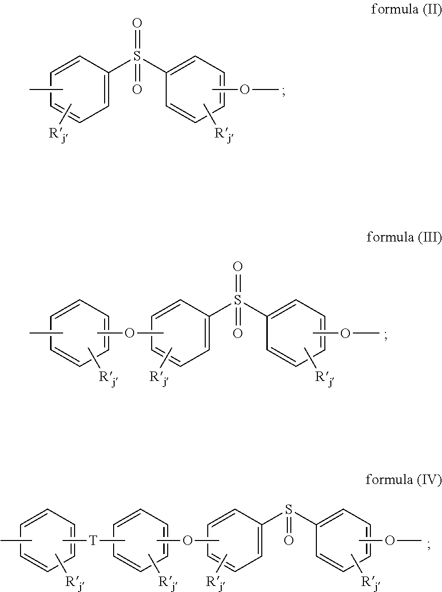

wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each of i′, equal to or different from each other and at each occurrence, is independently zero or is an integer from 0 to 4;
each of T, equal to or different from each other, is selected from the group consisting of a bond, —CH₂—; —O—; —S—; —C(O)—; —C(CH₃)₂—; —C(CF₃)₂—;

—C(═CCl₂)—; —C(CH₃)(CH₂CH₂COOH)—; —N═N—; —R^{a}C═CR^{b}—; where each R^{a} and R^{b}, independently of one another, is a hydrogen or a C₁-C₁₂-alkyl, C₁-C₁₂-alkoxy, or C₆-C₁₈-aryl group; —(CH₂)_{q}— and —(CF₂)_{q}— wherein q is and integer from 1 to 6, or an aliphatic divalent group, linear or branched, of up to 6 carbon atoms; and mixtures thereof.

Specific recurring units (R_{PESU}*) are typically selected from the group consisting of those of formula (A), (B) and (C) here below:

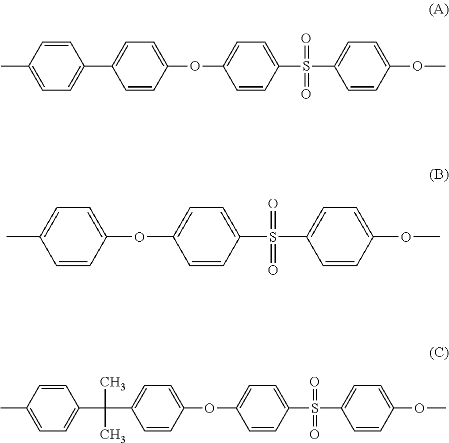

and mixtures thereof.

The polymer (PESU) may be a blend of the previously cited homopolymer and copolymer.

Preferably more than 75% by moles, preferably more than 85% by moles, preferably more than 95% by moles, preferably more than 99% by moles of the recurring units of the polymer (PESU) are recurring units (R_{PESU}), as defined above.

Most preferably, all the recurring units of the polymer (PESU) are recurring units recurring units (R_{PESU}), as defined above, chain defects, or very minor amounts of other units might be present, being understood that these latter do not substantially modify the properties.

Non-limiting examples of polymers (PESU) suitable for the invention include, for instance, those described in WO 2014/072447 (SOLVAY SPECIALTY POLYMERS ITALY S.P.A.) 15 May 2014.

Non-limiting examples of polymers (PESU) suitable for the invention include those commercially available under the trademark name VERADEL® PESU from Solvay Specialty Polymers USA L.L.C.

In a second preferred embodiment of the invention, the recurring units (R_{SP}) of the polymer (SP) are preferably recurring units (R_{SP-2}) of formula:

—Ar*¹—SO₂—[Ar*²-(T*-Ar*³)_{n*}—SO₂]_{m*}—Ar*⁴-E- (R_{SP-2})

wherein
each of Ar*¹, Ar*², Ar*³ and Ar*⁴, equal to or different from each other at each occurrence, is an aromatic moiety;
n* and m*, equal to or different from each other, are independently zero or an integer of 1 to 5;
T* is a bond or a divalent group optionally comprising one or more than one heteroatom; preferably T* is selected from the group consisting of a bond, —CH₂—, —C(CH₃)₂—, —C(CF₃)₂—, —C(═CCl₂)—, —C(CH₃)(CH₂CH₂COOH)—, and a group of formula:

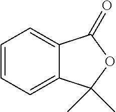

and
E is a 1,4:3,6-dianhydrohexitol sugar diol unit selected from one or more of formulae (E-1) to (E-3):

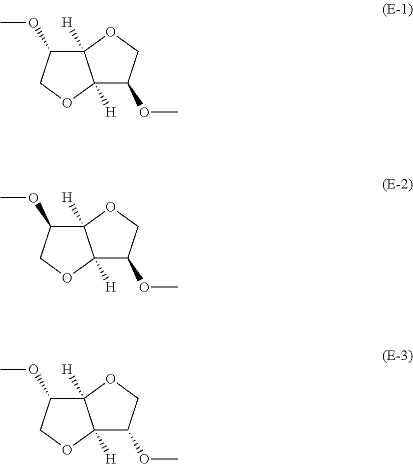

Preferred aromatic moieties Ar*¹—Ar*⁴ have the following structures:

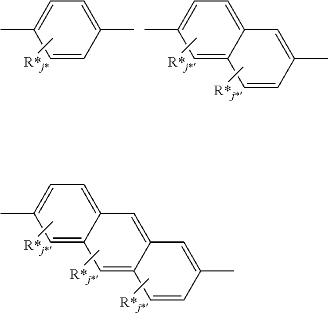

wherein:
each R* is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
j* is zero or an integer of 1 to 4 and j*′ is zero or an integer of 1 to 3.

Polymers (SP) according to this second preferred embodiment of the invention can be manufactured by reaction of at least one 1,4:3,6-dianhydrohexitol [diol (AA)] as defined above

with
at least one dihaloaryl compound [herein after dihalo (BB)] of formula (S):

X—Ar*¹—SO₂—[Ar*²-(T*-Ar*³)_{n*}—SO₂]_{m*}—Ar*⁴—X′

wherein:
X and X′, equal to or different from each other, are halogens selected from F, Cl, Br, I; preferably Cl or F; and
Ar*¹, Ar*², Ar*³, Ar*⁴, T*, n* and m* are as defined above.

A convenient method for manufacturing polymers (SP) according to this second preferred embodiment of the invention is disclosed in WO 2014/072473 (SOLVAY SPECIALTY POLYMERS ITALY S.P.A.) 15 May 2014, incorporated by reference herein.

Non limiting examples of polymers (SP) according to this second preferred embodiment of the invention include poly(isosorbide) polymers [polymers (PSI)].

For the purpose of the present invention, the term “poly(isosorbide) polymer [polymer (PSI)]” is intended to denote any polymer comprising recurring units wherein more than 30% by moles of the recurring units (R_{SP-2}) of said polymer (PSI) are recurring units (R_{PSI}) independently selected from one or more of those of formulae (R_{PSI}-1) and (R_{PSI}-2):

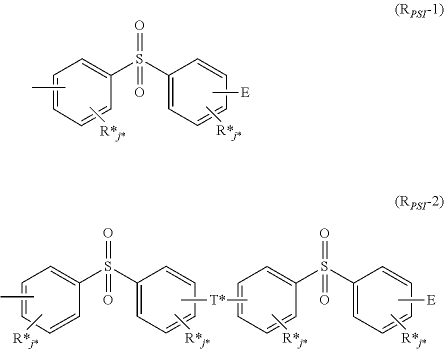

wherein:
each of R*, equal to or different from each other, is as defined above;
j* is as defined above;
T* is as defined above and is preferably selected from the group consisting of a bond, —CH₂—, —C(O)—, —C(CH₃)₂—, —C(CF₃)₂—, —C(═CCl₂)—, —C(CH₃)(CH₂CH₂COOH)—, —SO₂—, phenylene and a group of formula:

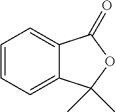

and
E is a 1,4:3,6-dianhydrohexitol sugar diol unit of formulae (E-1) [hereinafter also referred to as isosorbide unit (E-1)].

Recurring units (R_{PSI}-1) and (R_{PSI}-2) can be each present alone or in admixture.

More preferred polymers (PSI) are those comprising recurring units of formulae (R_{PSI}-1) and (R_{PSI}-2), wherein E is a 1,4:3,6-dianhydrohexitol sugar diol unit of formula (E-1), optionally in combination with one or more (R_{PSI}-1) and (R_{PSI}-2) units, wherein E is a 1,4:3,6-dianhydrohexitol sugar diol unit of formula (E-2) and/or (E-3) [hereinafter also referred to as isomannide and isoidide units (E-2) and (E-3), respectively].

Most preferred polymers (PSI) are those comprising recurring units of formula (R_{PSI}-1), wherein E is an isosorbide unit (E-1), optionally in combination with recurring units (R_{PSI}-1), wherein E is an isomannide unit of formula (E-2) and/or an isoidide unit of formula (E-3).

In recurring units (R_{PSI}-1) and (R_{PSI}-2), the respective phenylene moieties may independently have 1,2-, 1,4- or 1,3-linkages to the other moieties different from R* in the recurring units. Preferably, said phenylene moieties have 1,3- or 1,4-linkages, more preferably they have 1,4-linkages. Still, in recurring units (R_{PSI}-1) and (R_{PSI}-2), j* is at each occurrence zero, that is to say that the phenylene moieties have no other substituents than those enabling linkage in the main chain of the polymer.

Polymers (PSI) may optionally further comprise recurring units selected from one or more of:
recurring units (R_{A′A′}), deriving from the incorporation of at least one dihydroxyl compound [diol (A′A′)] different from diol (AA);
recurring units (R_{B′B′}), deriving from the incorporation of at least one dihaloaryl compound [dihalo (B′B′)] different from dihalo (BB);
recurring units (R_{A′B′}), deriving from the incorporation of at least one hydroxyl-halo compound [hydro-halo (A′B′)];
recurring units (R_{c}) of formula (S1):

Ar⁵-(T^{S1}-Ar⁶)_{q}—O—Ar⁷—SO₂—[Ar⁸-(T^{S1}′-Ar⁹)_{q}—SO₂]ₚ—Ar¹⁰—O—

wherein:
Ar⁵, Ar⁶, Ar⁷, Ar⁸ and Ar⁹, equal to or different from each other and at each occurrence, are independently an aromatic moiety;
T^{S1} and T^{S1}′, equal to or different from each other at each occurrence, are independently a bond or a divalent group optionally comprising one or more than one heteroatom; preferably T^{S1} and T^{S1}′ are selected from the group consisting of a bond, —CH₂—, —C(O)—, —C(CH₃)₂—, —C(CF₃)₂—, —C(═CCl₂)—, —C(CH₃)(CH₂CH₂COOH)—, —SO₂—, and a group of formula:

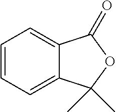

q and p, equal to or different from each other, are independently zero or an integer of 1 to 5.

Recurring units (R_{c}) can be notably selected from the group consisting of those of formulae (S1-A) to (S1-D) here below:

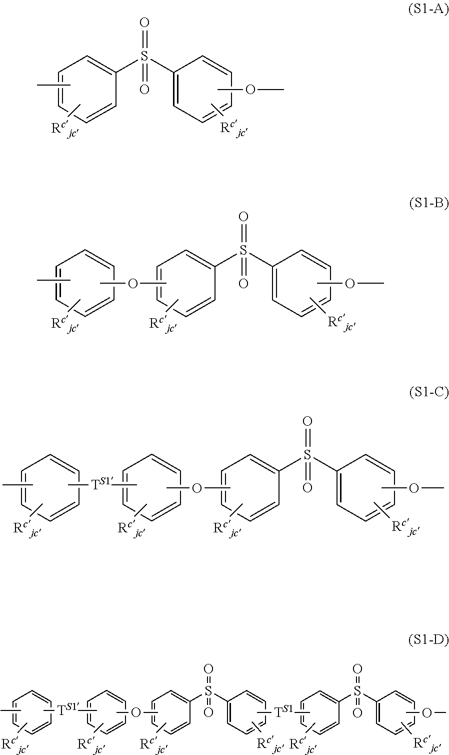

wherein:
each of R^{c}′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j^{c}′ is zero or is an integer from 0 to 4;
T^{S1} and T^{S1}′ are as defined above.

In recurring units of any of formulae (S1-C) to (S1-D), the respective phenylene moieties may independently have 1,2-, 1,4- or 1,3-linkages to the other moieties different from R′ in the recurring unit. Preferably, said phenylene moieties have 1,3- or 1,4-linkages, more preferably they have 1,4-linkages. Still, in recurring units of any of formulae (S1-C) to (S1-D), j^{c}′ is at each occurrence zero, that is to say that the phenylene moieties have no other substituents than those enabling linkage in the main chain of the polymer.

Polymers (PSI) typically comprise recurring units of formula (R_{PSI}) as defined above in an amount of at least 30% by moles, preferably 35% by moles, more preferably 40% by moles, even more preferably at least 50% by moles, with respect to all recurring units of polymers (PSI).

According to certain preferred embodiments, more than 70% by moles, and more preferably more than 85% by moles of the recurring units of the polymers (PSI) are recurring units (R_{PSI}), as defined above, the complement to 100% moles being generally recurring units (R_{c}) as defined above.

Methods for the manufacture of polymers (PSI) further comprising recurring units in addition to units (R_{PSI}) are also disclosed in the aforementioned WO 2014/072473 (SOLVAY SPECIALTY POLYMERS ITALY S.P.A.) 15 May 2014.

Preferably, the polymers (PSI) consist only of recurring units (R_{PSI}) as defined above, preferably recurring units (R_{PSI}-1), wherein (E) is an isosorbide unit of formula (E-1) and wherein the phenylene units have 1,4-linkages.

The polymers (PSI) have in general a weight average molecular weight of at least 20,000, preferably at least 30,000, more preferably at least 40,000. The weight average molecular weight (M_{w}) and the number average molecular weight (Mₙ) can be estimated by gel-permeation chromatography (GPC) using ASTM D5296 calibrated with polystyrene standards.

The weight average molecular weight (M_{w}) is:

$${M}_{w} = \frac{\sum {M}_{i}^{2} \cdot {N}_{i}}{\sum {M}_{i} \cdot {N}_{i}}$$

The number average molecular weight (Mₙ) is:

$${M}_{n} = \frac{\sum {M}_{i} \cdot {N}_{i}}{\sum {N}_{i}}$$

The polydispersity index (PDI) is hereby expressed as the ratio of weight average molecular weight (M_{w}) to number average molecular weight (Mₙ).

Polymers (PSI) generally have a polydispersity index of less than 2.5, preferably of less than 2.4, more preferably of less than 2.2. This relatively narrow molecular weight distribution is representative of an ensemble of molecular chains with similar molecular weights and substantially free from oligomeric fractions, which might have a detrimental effect on polymer properties.

Polymers (PSI) advantageously possess a glass transition temperature of at least 200° C., preferably 210° C., more preferably at least 220° C. Glass transition temperature (Tg) is generally determined by differential scanning calorimetry (DSC) according to ASTM D 3418 standard procedure.

According to an embodiment of the invention, the polymer (A) may be manufactured by polymerization in the presence of at least one compound (S) as defined above.

The liquid composition (C) typically comprises at least one polymer (A) in an amount of at least 10% by weight, preferably of at least 15% by weight, based on the total weight of the liquid composition (C). The liquid composition (C) typically comprises at least one polymer (A) in an amount of at most 70% by weight, preferably of at most 40% by weight, based on the total weight of the liquid composition (C).

The solid composition (C) typically comprises at least one polymer (A) in an amount of at least 90% by weight, preferably of at least 95% by weight, based on the total weight of the solid composition (C). The solid composition (C) typically comprises at least one polymer (A) in an amount of at most 99% by weight, preferably of at most 98% by weight, based on the total weight of the solid composition (C).

The compound (S) is advantageously an inorganic compound.

The compound (S) is preferably selected from the group consisting of silicates comprising one or more elements such as calcium, boron, aluminium, iron, magnesium, sodium, lithium or potassium.

The compound (S) is preferably selected from the group consisting of tourmaline, actinolite, serpentine, muscovite and kaolin. The compound (S) is more preferably tourmaline.

The composition (C) advantageously comprises at least one compound (S) in an amount of from 0.1% to 10%, preferably from 1% to 8%, more preferably from 1% to 6% by weight, based on the total weight of the at least one polymer (A).

The porous membrane of the invention comprises at least one layer consisting of a composition (C), said composition (C) preferably comprising at least one compound (S) in an amount of from 0.1% to 10%, preferably from 1% to 8%, more preferably from 1% to 6% by weight, based on the total weight of the at least one polymer (A).

The porous membrane of the invention comprises at least one layer consisting of a composition (C), said composition (C) more preferably comprising:
at least one polymer (A) in an amount of from 90% to 99% by weight, preferably from 95% to 98% by weight, and
at least one compound (S) in an amount of from 0.1% to 10%, preferably from 1% to 8%, more preferably from 1% to 6% by weight, based on the total weight of the at least one polymer (A).

The composition (C) may further comprise one or more oxides selected from the group consisting of titanium oxide, magnesium oxide, aluminium oxide, potassium oxide, zirconium oxide and/or one or more sulfates selected from the group consisting of barium sulfate, calcium sulfate strontium sulfate and/or one or more carbonates selected from the group consisting of calcium carbonate and sodium carbonate.

At least one compound (S) is preferably blended with one or more oxides and/or one or more sulfates and/or one or more carbonates. At least one compound (S) is more preferably blended with titanium oxide and/or barium sulfate. The total amount of one or more oxides and/or one or more sulfates and/or one or more carbonates blended with at least one compound (S) is comprised between 40% and 95% by weight, based on the total weight of the compound (S).

The composition (C) may contain one or more additional components, such as pore forming agents, nucleating agents, fillers, latent organic solvents, surfactants and the like.

Pore forming agents are typically added to the composition (C) in amounts usually ranging from 0.1% to 30% by weight, preferably from 0.5% to 5% by weight. Suitable pore forming agents are for instance polyvinylpyrrolidone (PVP) and polyethyleneglycol (PEG), with PVP being preferred.

Pore forming agents are generally at least partially, if not completely, removed from the porous membrane in the medium (NS), if any, under step (iii) of the process for manufacturing a porous membrane according to the first embodiment of the invention.

Non limiting examples of suitable latent organic solvents include hydrogenated plasticizers, in particular esters or polyesters such as citrates, phthalates, trimellitates, sabacates, adipates, azelates can be notably mentioned. Examples thereof may include: adipic acid-based polyesters of, e.g., the adipic acid-propylene glycol type, and the adipic acid-1,3-butylene glycol type; sebacic acid-based polyesters of, e.g., the sebacic acid-propylene glycol type; azelaic acid-based polyesters of e.g., the azelaic acid-propylene glycol type, and azelaic acid-1,3-butylene glycol type; alkyl phthalates like, e.g. di(2-ethyl hexyl) phthalate, diisononyl phthalate, diisodecyl phthalate; alkyl and acyl citrates, e.g. triethyl citrate, acetyl triethyl citrate, tri-n-butyl citrate, acetyl-tri-n-butyl citrate, trioctyl citrate, acetyl-tri-octyl citrate trihexyl citrate, acetyl-trihexyl citrate, butyryl-trihexyl citrate or trihexyl-o-butyryl citrate; alkyl trimelliltates, like notably trimethyl trimellitate, tri-(2-ethylhexyl)trimellitate, tri-(n-octyl,n-decyl) trimellitate tri-(heptyl,nonyl) trimellitate, n-octyl trimellitate.

Further, in addition, a limited amount of a medium (NS) for polymer (A) may be added to the liquid composition (C), in an amount generally below the level required to reach the cloud point, typically in amount of from 0.1% to 40% by weight, preferably in an amount of from 0.1% to 20% by weight, based on the total weight of the liquid composition (C).

Without being bound by this theory, it is generally understood that the addition of a medium (NS) to the liquid composition (C) will increase the rate of demixing/coagulation under step (iii) of the process for manufacturing a porous membrane according to the first embodiment of the invention thereby providing a more advantageous membrane morphology.

The porous membrane of the invention typically comprises at least one layer consisting of a composition (C) further comprising one or more additional components such as pore forming agents, typically in an amount of from 0.01% to 5% by weight, based on the total weight of the porous membrane.

The porous membrane of the invention may be either a self-standing porous membrane or a porous membrane supported onto a substrate.

A porous membrane supported onto a substrate is typically obtainable by impregnation of said substrate with said porous membrane.

The porous membrane of the invention may further comprise at least one substrate layer. The substrate layer may be partially or fully interpenetrated by the porous membrane of the invention.

The nature of the substrate is not particularly limited. The substrate generally consists of materials having a minimal influence on the selectivity of the porous membrane. The substrate layer preferably consists of non-woven materials.

The porous membrane of the invention may be a porous composite membrane comprising:
at least one substrate layer, preferably a non-woven substrate,
at least one top layer, and
between said at least one substrate layer and said at least one top layer, at least one layer consisting of a composition (C) as defined above.

Typical examples of such porous composite membranes are the so called Thin Film Composite (TFC) structures which are typically used in reverse osmosis or nanofiltration applications.

Non limiting examples of top layers suitable for use in the porous composite membrane of the invention include those made of polymers selected from the group consisting of polyamides, polyimides, polyacrylonitriles, polybenzimidazoles, cellulose acetates and polyolefins.

In a third instance, the present invention pertains to use of the porous membrane of the invention as filtration membrane for liquid and/or gas phases, in particular water-based phases.

Water-based media may comprise one or more microorganisms selected from the group consisting of bacteria such as Staphylococcus aureus and Pseudomonas aeruginosa, algae, fungi, protozoa and viruses.

Thus, in a fourth instance, the present invention pertains to a process comprising filtrating a liquid phase and/or a gas phase comprising one or more solid contaminants through the porous membrane of the invention.

The porous membrane of the invention is particularly suitable for use in a process comprising filtrating a water-based phase comprising one or more solid contaminants.

Non-limiting examples of solid contaminants include one or more microorganisms selected from the group consisting of bacteria such as Staphylococcus aureus and Pseudomonas aeruginosa, algae, fungi, protozoa and viruses.

Should the disclosure of any patents, patent applications, and publications which are incorporated herein by reference conflict with the description of the present application to the extent that it may render a term unclear, the present description shall take precedence.

The invention will be now described in more details with reference to the following examples, whose purpose is merely illustrative and not intended to limit the scope of the invention.

Raw Materials

VERADEL® 3000 P polyethersulfone (PESU).

PSI-A: polymer (PSI) of Example 3 of WO 2014/072473 (SOLVAY SPECIALTY POLYMERS ITALY S.P.A.) 15 May 2014.

Tourmaline water suspension (1) with D90<0.7 μm was prepared as described in WO 2010/013107 (RHODIA POLIAMIDA E ESPECIALIDADES LTDA) 4 Feb. 2010.

Tourmaline water suspension (2) contains a mixture of tourmaline (55% by weight of the total weight of said mixture), barium sulphate (20% by weight of the total weight of said mixture) and TiO₂ (25% by weight of the total weight of said mixture).

Tourmaline water suspension (3) contains a mixture of tourmaline (10% by weight of the total weight of said mixture), barium sulphate (25% by weight of the total weight of said mixture) and TiO₂ (65% by weight of the total weight of said mixture).

Measurement of Contact Angle (CA)

The contact angle towards water was evaluated at 25° C. by using the Dataphysics OCA 20, according to ASTM D 5725-99. Measures were taken on porous membranes and dense polymeric films. Only for porous membranes, in order to avoid collapsing of the pores due to the drying process, the pieces of the membranes used for the CA characterization were taken out from the washing bath and then immersed in ethanol for one night and finally air-dried. This is a common procedure found in the literature.

Measurement of Water Permeability

The pure water permeability is measured according to the technique known in the art. Water flux (J) through each membrane at given pressure, is defined as the volume which permeates per unit area and per unit time. The flux is calculated by the following equation:

J=V/(A×Δt)

where V (L) is the volume of permeate, A is the membrane area, and Δt is the operation time.

Water flux measurements were conducted at room temperature using a dead-end configuration under a constant nitrogen pressure of 1 bar. Membrane discs with an effective area of 11.3 cm² were cut from the items stored in water and placed on a metal plate. For each material, flux is the average of at least five different discs. The flux is expressed in LMH (litres/squared meter×hour).

Solution Preparation

Solutions were prepared by adding the opportune amount of tourmaline water suspension in the solvent (DMAC or NMP) and stirring with a mechanical anchor. At the end a proper amount of polymer (in powder or pellet form) was added while stirring for several additional hours.

Porous Membrane Preparation

Flat sheet porous membranes were prepared by filming the polymeric solution (polymer+solvent+tourmaline water suspension) over a suitable smooth glass support by means of an automatized casting knife. The solvent used was N-methyl-2-pyrrolidone (NMP). Membrane casting was performed by holding dope solutions, the casting knife and the support temperatures at 25° C., so as to prevent premature precipitation of the polymer. The knife gap was set to 250 μm. After casting, polymeric films were immediately immersed in a coagulation bath in order to induce phase inversion. The coagulation bath consisted of pure de-ionized water. After coagulation the membranes were washed several times in pure water during the following days to remove residual traces of solvent. The membranes were always stored (wet) in water.

Dense Film Preparation by Solution Casting

Flat dense polymeric films were prepared by filming the polymeric solution containing the polymer (A), tourmaline water suspension and an organic solvent over a suitable smooth glass support by means of an automatized casting knife at 40° C. The knife gap was set at 500 μm. The solvent used was N,N-dimethylacetamide (DMAC). After casting the films the solvent was left to evaporate in a vacuum oven at 130° C. for 4 hours.

Dense Film Preparation by Melt Extrusion

Flat dense polymeric films were obtained by melt extrusion by:

a) mixing the polymer (A) and a tourmaline water suspension and letting water evaporate in a vacuum oven at 90° C. for 4 hours, and

b) extruding the above mixed powder in a single screw extruder Brabender Plasticorder PLE 651 (19 mm/25 D) equipped with a film head (width=10 cm, adjustable thickness) at 300° C.

Measurement of Gravimetric Porosity

Gravimetric porosity of the membrane is defined as the volume of the pores divided by the total volume of the membrane. The porosities were measured using IPA (isopropyl alcohol) as wetting fluid according to the procedure described, for instance, in the Appendix of SMOLDERS, K., et al. Terminology for membrane distillation. Desalination. 1989, vol. 72, p. 249-262.

Mechanical Properties

Mechanical properties on flat sheet porous membranes were assessed at room temperature (23° C.) following ASTM D 638 standard procedure (type V, grip distance=25.4 mm, initial length Lo=21.5 mm). Velocity was between 1 and 50 mm/min. The samples (flat sheet porous membranes) stored in water were took out from the container boxes and immediately tested.

Determination of Biofouling Resistance

This method consists in the quantification of a biofilm formed on a polymer dense film sample obtained by solution casting according to the general procedure as detailed above by the gram negative bacteria Pseudomonas aeruginosa in water either under high shear conditions and continuous flow using a small reactor having a total volume of 1 litre (operating water volume is 500 ml for the batch phase and 300 ml for the continuous phase). This method follows ASTM E 2562-07 standard procedure with some technical adaptations to flat dense specimens (rectangle size of 50 mm×18 mm). The method is divided in two phases performed in sequence: batch phase and continuous phase.

Before the first phase (usually the day before), a liquid culture of Pseudomonas aeruginosa was prepared for 20-24 hours according to ASTM E 2562-07 standard procedure in order to obtain a concentration of 10⁸ CFU/ml. Before starting the experiment, the samples were aseptically screwed on rod holders which were placed in the reactor. As the whole experiment was made under sterile conditions, the whole material (reactor, tubes, connections, etc.) was previously sterilized by steam autoclaving. Specimens were also previously sterilized by a short dipping process (30 minutes) in a mixture ethanol/deionized water 70/30 v/v. Once the samples were placed in the reactor, the first phase (“batch phase”) was launched by inoculating in the reactor a 1 ml of the above culture.

This batch phase lasts 24 hours and corresponds to the (eventual) first adhesion of the planktonic cells to the surface of the items. Conditions are corresponding to a constant agitation of 120 rpm in the reactor made with a baffled stir bar to produce a high shear and a temperature of 25±2° C. At the end of this stage, samples were aseptically removed from the reactor in order to check the biofilm adhesion on them. In order to keep the same shear in the reactor, removed holder rods were replaced by fake rods.

Then, in a second step, the “continuous phase” was launched for another 24 hours. In this case the same agitation was imposed with a baffled stir bar. A water flux of nutrient (with a concentration defined in ASTM E 2562-07 standard procedure) was imposed with a peristaltic pump. This media renewal is necessary in order to make the biofilm grow in thickness on the sample surface of the specimens. The chosen flow rate is usually dependent on the bacterial species used and on the size of the reactor. In this case, the nutrient flow rate volume was fixed at 11.7 ml/min which roughly corresponds to a time of 30 minutes to completely exchange the water volume present in the reactor (this time is also equivalent to the generation time of the adhering P. aeruginosa cells; see GOTTENBOS, B., et al. Initial adhesion and surface growth of Staphylococcus epidermidis and Pseudomonas aeruginosa on biomedical polymers. J. Biomed. Mater. Res. 2000, vol. 50, no. 2, p. 208-214).

After each of the two phases as described above, the dense film samples were aseptically removed from the reactor in order to analyse and quantify the biofilm accumulated on them.

Biofilm analysis requires 4 successive steps (described in ASTM E 2562-07 standard procedure) which can be briefly described as:
1. dense film removal from the rod holder and rinsing with a phosphate-buffered saline solution (PBS) to remove planktonic cells,
2. biofilm removal from the dense film by sonication followed by vortexing,
3. biofilm clumps disaggregation in order to obtain a homogeneous cell suspension, and
4. serial dilutions of the cell suspension for cell enumeration with a culture of each dilution for colony growth.

Results on biofilm accumulation (i.e. quantification of the amount of biofilm formed during the two phases) are expressed in LOG 10 CFU/cm² where CFU stands for Colony Forming Unit.

An eventual lower amount of biofilm (measured at the end of either the batch phase or the continuous phase) than in the case of the reference sample is an indication of lower bio-fouling propensity of the material under scrutiny.

This test may be performed only on dense films in order to assess the intrinsic biofouling propensity of the material under scrutiny.

This test cannot be executed on porous membranes at least for the following reasons:
1. It is very difficult to remove the total amount of biofilm accumulated onto a porous membrane due the large internal area of porous specimens. This means that the counting procedure is then affected by strong errors.
2. Beside the material itself, the morphology of the membrane (porosity, thickness, pore size distribution, surface porosity, etc.) could have an impact on the obtained numbers strongly biasing the quality of the test.

### EXAMPLE 1

Porous membranes were manufactured using the following liquid casting solutions comprising NMP as solvent:

1) a liquid solution comprising 20% by weight of VERADEL® 3000 P PESU to which the tourmaline water suspension (1) was added in such an amount so as to reach a concentration of tourmaline of 2% by weight based on the total weight of VERADEL® 3000 P PESU. The membrane was coagulated in water. The membrane had a contact angle of the upper side towards water of 510. The porosity was 79% and the water flux was 550 LMH;

2) a liquid solution comprising 20% by weight of VERADEL® 3000 P PESU to which the tourmaline water suspension (1) was added in such an amount so as to reach a concentration of tourmaline of 4% by weight based on the total weight of VERADEL® 3000 P PESU. The membrane was coagulated in water. The membrane had a contact angle of the upper side towards water of 55°. The porosity was 80% and the water flux was 680 LMH.

### COMPARATIVE EXAMPLE 1

The same procedure as detailed under Example 1 was followed but using a liquid casting composition comprising NMP as solvent and 20% by weight of VERADEL® 3000 P PESU. No tourmaline was added to the casting composition. The membrane had a contact angle of the upper side towards water of 56°. The porosity was 78% and the water flux was 3 LMH.

The mechanical properties values of the porous membranes obtained according to Example 1 and Comparative Example 1 are shown in Table 1 here below:

TABLE 1

| | Example 1 | C. Example 1 |
|---|---|---|
| Modulus [MPa] | 159 | 154 |
| Stress at break [MPa] | 5.2 | 4.4 |
| Strain at break [%] | 33 | 17 |

### EXAMPLE 2

Dense films were manufactured using a liquid casting solution comprising DMAC as solvent and 15% by weight of VERADEL® 3000 P PESU to which the tourmaline water suspension (1) was added in such an amount so as to reach a concentration of tourmaline of 2% by weight based on the total weight of VERADEL® 3000 P PESU.

### COMPARATIVE EXAMPLE 2

The same procedure as detailed under Example 2 was followed but using a liquid casting composition comprising DMAC as solvent and 15% by weight of VERADEL® 3000 P PESU. No tourmaline was added to the casting composition.

The biofilm accumulation values on the porous membranes obtained according to Example 2 and Comparative Example 2 are shown in Table 2 here below:

TABLE 2

| | Example 2 | C. Example 2 |
|---|---|---|
| Batch phase | 5.8 LOG10 CFU/cm² | 6.5 LOG10 CFU/cm² |
| Continuous phase | 6.8 LOG10 CFU/cm² | 7.6 LOG10 CFU/cm² |

### EXAMPLE 3

Dense films were manufactured using a liquid casting solution comprising DMAC as solvent and 15% by weight of PSI-A to which the tourmaline water suspension (1) was added in such an amount so as to reach a concentration of tourmaline of 6% by weight based on the total weight of PSI-A.

### COMPARATIVE EXAMPLE 3

The same procedure as detailed under Example 3 was followed but using a liquid casting composition comprising DMAC as solvent and 15% by weight of PSI-A. No tourmaline was added to the casting composition.

The biofilm accumulation values on the porous membranes obtained according to Example 3 and Comparative Example 3 are shown in Table 3 here below:

TABLE 3

| | Example 3 | C. Example 3 |
|---|---|---|
| Batch phase | 6.1 LOG10 CFU/cm² | 6.5 LOG10 CFU/cm² |

Determination of Antibacterial Activity

This method consists in the quantification of bacteria before and after exposure of a polymeric film with a predefined surface to bacteria according to JIS Z2801 standard procedure. Bacteria in the strain inoculum are either Escherichia coli or Pseudomonas aeruginosa or Staphylococcus aureus. The specimens are 5×5 cm² flat dense films obtained either by solution casting or by melt extrusion according to the general procedure as detailed above using the tourmaline water suspension (2) or the tourmaline water suspension (3).

After sterilization of the films, a strain inoculum (approximately 0.4 ml) was deposited on the surfaces of the films. Strain inoculum concentration was in the range 2.5-10×10⁵ cells/ml. The petri dish containing the inoculated test piece with the test inoculum was then incubated for 24 hours at a temperature of 35° C. and a relative humidity of 90%. After the incubation period, a wash out procedure was executed in order to collect the bacteria and to measure them with an agar plate culture method.

### EXAMPLE 4

A strain inoculum containing Escherichia coli was deposited on a VERADEL® 3000 P PESU dense film obtained either by solution casting, using a liquid casting solution comprising DMAC as solvent and 15% by weight of VERADEL® 3000 P PESU, or by melt extrusion according to the general procedure as detailed above using the tourmaline water suspension (2) in such an amount so as to reach a concentration of 2% by weight based on the total weight of VERADEL® 3000 P PESU of a mixture of tourmaline (55% by weight of the total weight of said mixture), barium sulphate (20% by weight of the total weight of said mixture) and TiO₂ (25% by weight of the total weight of said mixture).

### EXAMPLE 5

The same procedure as detailed under Example 4 was followed but using the tourmaline water suspension (3) in such an amount so as to reach a concentration of 4% by weight based on the total weight of VERADEL® 3000 P PESU of a mixture of tourmaline (10% by weight of the total weight of said mixture), barium sulphate (25% by weight of the total weight of said mixture) and TiO₂ (65% by weight of the total weight of said mixture).

### EXAMPLE 6

The same procedure as detailed under Example 4 was followed but depositing a strain inoculum containing Pseudomonas aeruginosa on a VERADEL® 3000 P PESU dense film obtained either by solution casting or by melt extrusion using the tourmaline water suspension (2) in such an amount so as to reach a concentration of 4% by weight based on the total weight of VERADEL® 3000 P PESU of a mixture of tourmaline (55% by weight of the total weight of said mixture), barium sulphate (20% by weight of the total weight of said mixture) and TiO₂ (25% by weight of the total weight of said mixture).

### EXAMPLE 7

The same procedure as detailed under Example 6 was followed but using the tourmaline water suspension (3) in such an amount so as to reach a concentration of 4% by weight based on the total weight of VERADEL® 3000 P PESU of a mixture of tourmaline (10% by weight of the total weight of said mixture), barium sulphate (25% by weight of the total weight of said mixture) and TiO₂ (65% by weight of the total weight of said mixture).

### EXAMPLE 8

A strain inoculum containing Pseudomonas aeruginosa was deposited on a VERADEL® 3000 P PESU dense film obtained either by solution casting, using a liquid casting solution comprising DMAC as solvent and 15% by weight of VERADEL® 3000 P PESU, or by melt extrusion according to the general procedure as detailed above using the tourmaline water suspension (2) in such an amount so as to reach a concentration of 6% by weight based on the total weight of VERADEL® 3000 P PESU of a mixture of tourmaline (55% by weight of the total weight of said mixture), barium sulphate (20% by weight of the total weight of said mixture) and TiO₂ (25% by weight of the total weight of said mixture).

The dense film so obtained was coated with an additional thin layer (20 μm) made of SOLEF® 1015 PVDF applied via press plates.

### EXAMPLE 9

The same procedure as detailed under Example 8 was followed but using a strain inoculum containing Staphylococcus aureus.

### COMPARATIVE EXAMPLE 4

The same procedure as detailed under Example 4 was followed but using a VERADEL® 3000 P PESU dense film obtained either by solution casting or by melt extrusion according to the general procedure as detailed above without adding a tourmaline water suspension.

### COMPARATIVE EXAMPLE 5

The same procedure as detailed under Example 6 was followed but using a VERADEL® 3000 P PESU dense film obtained either by solution casting or by melt extrusion according to the general procedure as detailed above without adding a tourmaline water suspension.

The antibacterial activity values on the dense films obtained according to Examples 4-9 and Comparative Example 4 are shown in Table 4 here below:

TABLE 4

| | Number of bacteria | Number of bacteria after |
|---|---|---|
| | before exposure | contact for 24 hours |
| Example 4 | 2.9 × 10⁵ | 2.1 × 10⁵ |
| Example 5 | 2.9 × 10⁵ | 2.0 × 10⁵ |
| Example 6 | 1.8 × 10⁵ | 1.1 × 10⁵ |
| Example 7 | 1.8 × 10⁵ | 1.0 × 10⁵ |
| Example 8 | 2.7 × 10⁵ | 1.2 × 10² |
| Example 9 | 2.4 × 10⁵ | 7.1 × 10² |
| C. Example 4 | 2.9 × 10⁵ | 3.2 × 10⁵ |
| C. Example 5 | 1.8 × 10⁵ | 2.1 × 10⁵ |

It has been thus found that the porous membrane of the invention advantageously exhibits improved biofouling resistance and improved mechanical properties to be suitably used as filtration membrane for various liquid and/or gas phases, in particular water-based phases.

Also, it has been found that the porous membrane of the invention advantageously exhibits good water flux properties to be suitably used as filtration membrane for water-based phases.

Further, it has been found that a significant decrease of bacteria is always observed on dense films after exposure to a strain inoculum.

1. A porous membrane comprising at least one layer consisting of a composition (C), said composition (C) comprising:
at least one aromatic polymer (A), and
at least one silicate compound (S) selected from the group consisting of tourmaline, actinolite, serpentine, muscovite and kaolin.

2. The porous membrane according to claim 1, wherein polymer (A) is selected from the group consisting of poly(ether sulfone) polymers (PESU) wherein more than 50% by moles of recurring units of said polymer (PESU) are recurring units of formula: 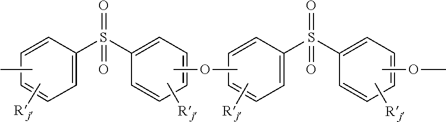
wherein each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium, and each of j′, equal to or different from each other and at each occurrence, is independently zero or is an integer from 0 to 4.

3. The porous membrane according to claim 1, wherein composition (C) comprises at least one compound (S) in an amount of from 0.1% to 10%, based on the total weight of the at least one polymer (A).

4. The porous membrane according to claim 1, wherein composition (C) further comprises:
one or more oxides selected from the group consisting of titanium oxide, magnesium oxide, aluminium oxide, potassium oxide, zirconium oxide; and/or
one or more sulfates selected from the group consisting of barium sulfate, calcium sulfate strontium sulfate; and/or
one or more carbonates selected from the group consisting of calcium carbonate and sodium carbonate.

5. The porous membrane according to claim 1, said porous membrane further comprising at least one substrate layer.

6. The porous membrane according to claim 1, said porous membrane comprising:
at least one substrate layer,
at least one top layer made of a polymer selected from the group consisting of polyamides, polyimides, polyacrylonitriles, polybenzimidazoles, cellulose acetates and polyolefins, and
between said at least one substrate layer and said at least one top layer, at least one layer consisting of a composition (C).

7. A process for manufacturing the porous membrane according to claim 1, said process comprising:
processing a liquid composition (C) thereby providing a film, said liquid composition (C) comprising:
at least one aromatic polymer (A),
at least one silicate compound (S) selected from the group consisting of tourmaline, actinolite, serpentine, muscovite and kaolin, and
a medium (L), wherein medium (L) is a liquid medium comprising at least one organic solvent;
and
precipitating the film.

8. The process according to claim 7, wherein the film is precipitated in a non-solvent medium (NS).

9. The process according to claim 7, wherein the film is precipitated by cooling.

10. The process according to claim 7, wherein the film is precipitated by absorption of a non-solvent medium (NS) from a vapour phase.

11. The process according to claim 7, wherein the film is precipitated by evaporation of the medium (L).

12. A process for manufacturing the porous membrane according to claim 1, said process comprising:
processing a solid composition (C) thereby providing a film, said solid composition (C) comprising:
at least one aromatic polymer (A), and
at least one silicate compound (S) selected from the group consisting of tourmaline, actinolite, serpentine, muscovite and kaolin;
and
stretching the film.

13. A process comprising filtering a liquid phase or a gas phase comprising one or more solid contaminants through the porous membrane according to claim 1.

14. The process according to claim 13, wherein the liquid phase is a water-based phase comprising one or more microorganisms selected from the group consisting of bacteria, algae, fungi, protozoa and viruses.

15. The process according to claim 14, wherein the bacteria is Staphylococcus aureus and/or Pseudomonas aeruginosa.

16. The porous membrane according to claim 3, wherein composition (C) comprises at least one compound (S) in an amount of from 1% to 6% by weight, based on the total weight of the at least one polymer (A).
